(19) United States
(12) Patent Application Publication
(10) Pub. No.: US 2025/0225329 A1
(43) Pub. Date: Jul. 10, 2025

(54) GENERATIVE AI FOR EXPLAINABLE AI

(71) Applicant: Microsoft Technology Licensing, LLC, Redmond, WA (US)

(72) Inventors: Gurucharan RAGHUNATHAN, Bengaluru (IN); Yafet TAMENE, Atlanta, GA (US); Yuchao DAI, Suzhou (CN)

(21) Appl. No.: 18/443,288

(22) Filed: Feb. 15, 2024

(30) Foreign Application Priority Data
Jan. 5, 2024 (IN) 202411001123

(51) Int. Cl. G06F 40/30; G06F 21/55

(52) U.S. Cl. CPC G06F 40/30; G06F 21/55

(57) ABSTRACT

A computer-implemented method comprising: receiving an explanation request comprising a feature and a machine learning (ML) prediction corresponding to the feature; obtaining context information based on the request; generating, using a first generative ML model instance applied to the feature and the ML prediction, at least two response variations; determining, using a second generative ML model instance applied to the context information and the at least two response variations, a ranking of the at least two response variations according to relevance; determining an explanation of the prediction based on the ranking of the at least two response variations; and performing a physical and/or logical operation based on the explanation.

### TECHNICAL FIELD

The present disclosure relates to methods, systems and computer programs for explainable Artificial Intelligence (XAI). According to some examples, generative AI is used to provide XAI.

### BACKGROUND

XAI can be used by an AI system to provide explanations to users for decisions or predictions of the AI system. This helps the system to be more transparent and interpretable to the user, and also helps troubleshooting of the AI system to be performed. When a user engages with an AI product, XAI can be used to explain results from the product in the form of insights and/or information to the user. For example, in the cybersecurity industry, XAI can be used to explain false negatives (missed bad traffic) and the false positives (wrongly classifying good traffic as bad), to improve the effectiveness of the product.

SHAP (Shapley Additive exPlanations) are a framework used in XAI. SHAP values can explain the output of a machine learning model by assigning contributions to each input feature of the AI model to indicate how much each feature contributes to the model's prediction of a specific instance. This helps user understand the impact of different features on the model's decisions.

LIME (Local interpretable Model-agnostic Explanations) is another technique in the field of XAI. LIME works by generating models that approximate the behaviour of a complex Machine Learning (ML) model around a specific instance. By perturbing the input data and observing changes in the model's predictions, LIME constructs an interpretable representation of how the model is making decisions. This can help users gain insights into why a particular prediction was made.

### SUMMARY

According to an aspect disclosed herein, there is provided a method for providing an explanation for a ML prediction being given for a feature. An explanation request is received with the feature and the ML prediction. A response to the explanation request is generated using a first Large Language Model (LLM) and then evaluated using a second LLM.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Nor is the claimed subject matter limited to implementations that solve any or all the disadvantages noted herein.

### BRIEF DESCRIPTION OF THE DRAWINGS

To assist understanding of the present disclosure and to show how embodiments may be put into effect, reference is made by way of example to the accompanying drawings in which:

FIG. 1 is a schematic representation of a current XAI approach;

FIG. 2 is a schematic representation of an example XAI approach;

FIG. 3 is an example workflow for providing XAI;

FIG. 4 is an example workflow for providing XAI in a cybersecurity context;

FIG. 5 shows an example XAI response that may be output using the method of FIG. 1 and an example XAI response that may be output using the method of any of FIG. 2 to 4;

FIG. 6 is a schematic illustration of a computing apparatus for implementing a neural network; and

FIG. 7 shows an example method flow.

### DETAILED DESCRIPTION

The described embodiments provide an XAI architecture, which uses generative AI to explain outputs generated by another AI system. The explanation can be used to perform a physical and/or logical operation. Systems and methods incorporating the aforementioned approach are described below. An AI system means a system that uses a machine learning (ML) model (or a collection of such models) generate outputs based on received inputs. Generative AI means a system that uses a generative ML models (or collection of such models), such as a transformer or other generative neural network, which has (or have) been trained in a manner that enables it (or them) to explain an output that has been generated by a second ML model, such as a discriminate ML model (e.g. discriminative classification or regression model). Thus, a first ML model(s) (which is generative) is used to explain the output of a second ML model (which may be discriminative or generative). LLMs, such as Generative Pre-trained Transformer 4 (GPT-4), are examples of generative ML models designed to understand and generate human-like text. LLMs are trained on large amounts of data (including, for example, textual data, image data audio data, multi modal data, etc.) and use deep learning techniques such as transformer architectures.

When an AI system outputs a prediction (such as a classification, score, regression value or other computed output), the reasons for the prediction may not be readily apparent. For example, a prediction outputted by a discriminative neural network may be hard to explain. Increasingly, systems rely on such predictions to automate actions. For example, in a cybersecurity system, a classification of an entity (such as an email or other message, a file, a computer program or script, a user account, a device, a service etc.) as ‘malicious’ might trigger a security mitigation action such as blocking, isolating or restricting the entity. Equally, a classification of an entity as ‘not malicious’ would mean such action is not triggered. If the reasons for the prediction are unclear, the reasons for the automated action (or lack of action) will be equally unclear. Incorrect predictions can have serious consequences. In a cybersecurity context, a false negative (missed detection) can have catastrophic consequences though failure to prevent activity by a malicious entity. False positives can also have severe consequences, particularly if they occur too frequently, as access to devices, systems, services etc. will be restricted unnecessarily. An improved explanation of why a prediction was output by an AI system is a key insight, as it enables issues within such systems to be identified and mitigated (e.g., through re-training, fine-tuning etc.). For example, an improved explanation of a false positive or false negative can assist in identifying and mitigating an issue that caused the false positive or false negative. Improved explainability can also be useful providing assurances to a user of an AI system that the AI system is reliable. For example, in a cybersecurity context, if a cybersecurity classifies an entity as ‘malicious’ or not ‘malicious’, a corresponding explanation may be generated and rendered within a graphical user interface (GUI) that is provided for analysis or debugging purposes in a human-interpretable manner (in contrast to more abstract forms of information provided by conventional systems that do not indicate actionable insights). For example, in a cybersecurity context, the techniques described herein can be used to generate an explanation of a given output in terms that are readily understood by a security expert, such as an explanation that a ‘bad’ traffic classification has arisen because of an anomalous behavior pattern, a bad reputation of an Indicators of Compromise (IOC), a suspicious intent or other similar evidence.

Current XAI models (e.g., SHAP and LIME) are limited by computational complexity and scalability issues. Further, current XAI models struggle to understand context and to provide model-specific interpretations. Current XAI models have difficulty using large datasets and explaining decisions made by complex models. These models offer only generic explanations that cannot capture model-specific nuances and lack domain-specific context in their analysis.

Examples described herein utilize generative LLMs such as GPT-4 to provide XAI to a user or system component. The use of LLMs provides a more scalable and efficient approach to interpret AI models. Further, LLMs can generate tailored explanations for different model architecture. The advanced processing capabilities of LLMs can reduce computational demands in comparison to using SHAP or LIME based techniques. Additionally, LLMs bring a nuanced understanding of context, providing richer, domain-specific explanations.

The XAI architecture described herein can be used to provide explanations of predictions output from an AI model. As described below, the XAI architecture described herein is agnostic to the AI model type. If a user has determined using another method a different value or prediction to the AI model output, the user can use the XAI's explanation to cross reference their own determination with the output from the AI model, and then determine whether their determination is correct or the AI model's determination is correct. If it is determined that the AI model's output value/prediction is incorrect and the user's determination made using a different method is correct, the explanation can be used to tune parameters (e.g., weights) of the AI model to increase the AI model's accuracy. If it is determined that the AI model's output value/prediction is correct and the user's determination made using a different method is incorrect, the explanation can be used to explain adjust the process used in the user's different method.

The XAI's explanation can also be useful for identifying false positives or false negatives determined by the AI model. Identifying false positives or false negatives can be useful, for example, in cybersecurity applications to prevent cybersecurity mitigation actions either not being performed against a malicious actor or being performed against a non-malicious actor. A cybersecurity mitigation action may, for example, comprise automatically isolating a malicious actor from a network, removing or restricting privileges of a malicious actor, or generating an alert identifying the malicious actor at a user interface (e.g., to prompt a review by a human security expert). Alternatively or additionally, such action may comprise gathering additional details relating to the malicious actor and using an additional detection component to make a further determination of the status of the malicious actor. Ensuring that a cybersecurity mitigation action is performed for a correctly identified malicious actor improves security. Further, ensuring that unnecessary cybersecurity mitigation actions are not performed against actors incorrectly identified as malicious reduces processing requirements.

The XAI explanation can be used for performing a physical and/or logical operation based on the explanation. For example, based on the explanation of the prediction (e.g., when the explanation of the prediction indicates that the prediction was made for a particular reason and/or when the explanation of the prediction indicates a predefined category of explanation), at least one of the following may be performed:
A cybersecurity mitigation action;
Validating an image classification;
Performing an industrial process (e.g., controlling a factory process);
Verifying a network configuration;
Controlling a vehicle.

When a user inquiry is received for an explanation for a value output from an AI model, the XAI explanation may be provided to a user via a user interface (e.g. graphical user interface), such as an analysis portal. The analysis portal may comprise a platform where engagement between a user and a product takes place. The analysis portal may provide XAI explanations of AI model outputs to the user. The analysis portal may also be used by a user to configure the product, visualize the product and view reports from the product. Currently, the explanation for the AI results be provided by results from the AI model (e.g., SHAP values or LIME interpretations), which are usually abstract or not contextual, or by a predefined schema of static strings correlated with status codes of the logical steps of the model. The response is neither intuitive to the user nor has the capability to generate dynamic response. With increased ML contribution in the product's core capabilities, it becomes less useful for the user persona to share static inference on the comprehensive data points. The maintenance of the data layer to generate results/response for all the inquiry scenarios is deterministic and not scalable. Examples described herein provide a method that leverages LLMs to give more intuitive and dynamic XAI responses.

Returning to the example of cybersecurity XAI products, cybersecurity personnel (e.g., Security operations (SecOps) admin or Security Operations Centre (SOC) analysts) may report false negatives and/or false positives that are missed or incorrectly categorized by a product through submissions in a analysis portal, for example. The cybersecurity personnel may request a response via the analysis portal. Using current XAI models, boilerplate text is generated based on SHAP values or LIME interpretations, for example. According to some examples described herein, statements describing the model output are generated utilizing generative LLMs (such as GPT-4) and provided to the cybersecurity personnel.

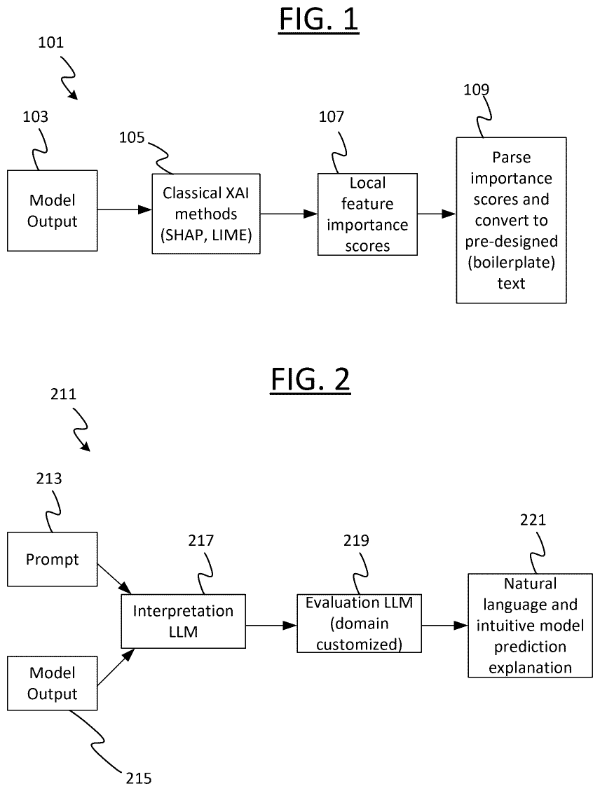

FIG. 1 shows by way of context a more conventional XAI approach 101. At 103, an output from an AI model is received. At 105, classical XAI methods such as SHAP or LIME are used with model output 103 as an input. The classical XAI methods provide local feature importance scores at 107. These importance scores are then parsed at 109, and pre-designed (boilerplate) text corresponding to the importance scores is determined and provided to the user.

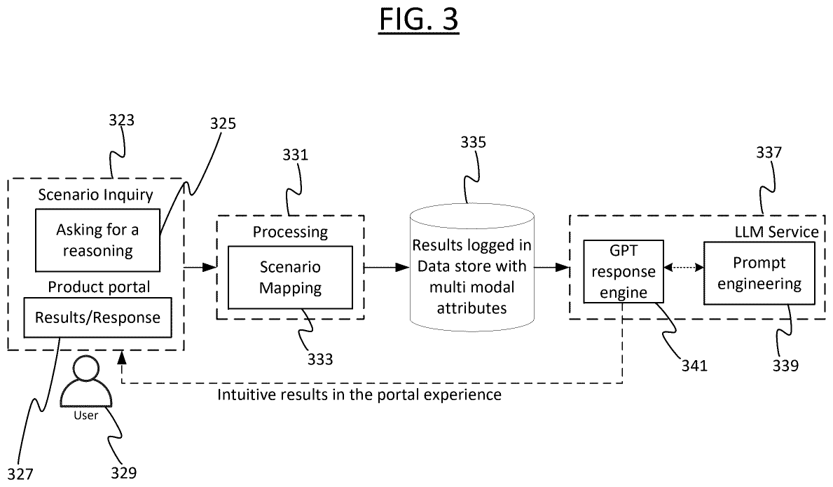

FIG. 2 shows an XAI approach 211 leveraging generative ML models. Although LLMs are shown in FIG. 2, it should be understood that other generative ML models can be used in other examples. A prompt 213 is input into an interpretation generative ML model 217 (e.g., an LLM). Prompt 213 may be based on a template for a scenario. An example prompt template is shown in Table 1, towards the end of the detailed description. According to some examples, different templates may be designed for different scenarios using few-shot learning. The templates may comprise instruction information for interpretation LLM 217 as well as context information to interpretation LLM 217. The instruction information may comprise one or more instructions to interpretation LLM 217. The one or more instructions may comprise at least one of:
an instruction to provide an explanation for why the model used to provide output 215 provided output 215;
an instruction specifying the type of explanation that should be provided (e.g., an instruction to provide a concise or lengthy response; an instruction to provide a formal or more informal response);
an instruction to consider one or more features in the context information when generating the explanation (such as features of the model used to provide output 215, definitions of the labels used by the model to provide output 215).
   The context information may comprise at least one of the following:
information describing the AI model being used to provide model output 215;
information describing the definitions of labels (label meta data) used by the AI model to provide the output 215.
   The prompt template may also act as a placeholder for at least one raw data attribute that is input into the AI model to provide model output 215. In some examples, all the raw data attributes that are input into the AI model to provide model output 215 have a placeholder in the prompt template. The template placeholders can be populated using the raw data attributes. The population of the prompt template is discussed below with respect of FIG. 3. Values of raw data attributes that are input into the AI model to provide model output 215 may be stored in a feature vector. The values from the feature vector can then be used to populate the placeholders in the prompt template, where each placeholder corresponds to a feature of the feature vector.

The model output 215 (which may comprise a feature) that requires explanation from the XAI 211 is also input into interpretation LLM 217. Interpretation LLM 217 may comprise any suitable LLM, for example GPT-4. Interpretation LLM 217 then use prompt 213 and model output 215 to generate a response for the prompt. The response may comprise a natural language explanation of why model output 215 was given by the AI model.

In some examples, more than one prompt may be input into interpretation LLM 217. For example, different prompt variations may be used to generate different response variations. In some examples, variations in the response may be generated for each prompt for each model output 215 (for example, three variations may be generated for each prompt for each model output 215). Multiple response variations can be generated based on a given input in various ways. Typically LLM's and other generative models generate probabilistic outputs from which multiple output can be sampled. For example, a generative model may perform recursive ‘next token’ prediction whereby given an input sequence, the generative model computed a probability distribution over a next token in the sequence. A next token can then be sampled from this, added to the input sequence (or part of it), resulting in an updated input sequence that is fed back to the model (and so on). Different candidate responses can be generated by sampling multiple next tokens, and using the candidate tokens to generate multiple updated input sequences. As another example, certain generative models have configurable runtime parameter(s), such as a temperature parameter controlling stochasticity (or ‘randomness’) of its outputs. Different responses may be generated with different values of a temperature parameter of the generative model and/or another runtime parameter. As another example, different candidate responses may be generated based on different prompts. The response variations are candidate responses, from which a final response is selected.

The output of interpretation LLM 217 is input into evaluation LLM 219. Note, interpretation LLM 217 and evaluation LLM 219 may be separate instances of the same underlying model but operating with different contexts. For example, interpretation LLM 217 and evaluation LLM 219 may be implemented as separate ‘chat’ sessions with the same underlying model. First and second model instances may, in general, be instances of the same underlying model or instances of different underlying models. Evaluation LLM 217 may comprise any suitable LLM, for example GPT-4. The evaluation LLM 219 evaluates the most appropriate response from the candidate responses output from interpretation LLM 217. The evaluation of the response variations can be performed by using context information from the prompt 213 to determine whether the response is relevant to the prompt. Further, this can also be performed by comparing the variations of the response and determining which responses are not consistent with the others. In some examples, the evaluation of the response variations can be performed using external context information that is input separately to prompt 213. In some examples, a combination may be used of at least one of external context information; context information from prompt 213; and comparing variations of the response for self-consistency. Response variations that are consistent with other response variations can be evaluated as more likely to be appropriate than other response variations. A priority score can then be assigned for each of the response variations.

The response variation having the highest priority score can then be assessed according to rules for providing the natural language and intuitive model prediction explanation. At least one rule may then be used to ensure that the response variation is appropriate, for example rules to ensure that the response satisfies criteria such as relevance; clarity; tone; adherence to a specific style guide; etc. At least one rule may be alternatively or additionally used to ensure that interpretation LLM 217 or evaluation LLM 219 is not hallucinating (e.g., a fact checking mechanism may be used). If the rules are satisfied by the response variation, the response variation may then be provided to the user as a natural language model prediction explanation. If the rules are not satisfied, the interpretation LLM 217 may be used in a further iteration to produce response variations which are assessed by evaluation LLM 219. The failure of the response variation to satisfy the rules may be fed back to interpretation LLM 217 and/or evaluation LLM 219 in order to train the respective LLM in the next iteration. In other examples, interpretation LLM 217 and/or evaluation LLM 219 may be varied without feedback. In some examples, prompt 213 may also be varied in the next iteration. This may be repeated iteratively until a response variation satisfying the rules is provided as an output from evaluation LLM 219. At 221, the response variation can be output to a user, and/or a physical or logical operation can be performed based on the explanation. For example, if the explanation indicates that an entity is a cybersecurity threat, a cybersecurity threat mitigation action can be performed based on the explanation.

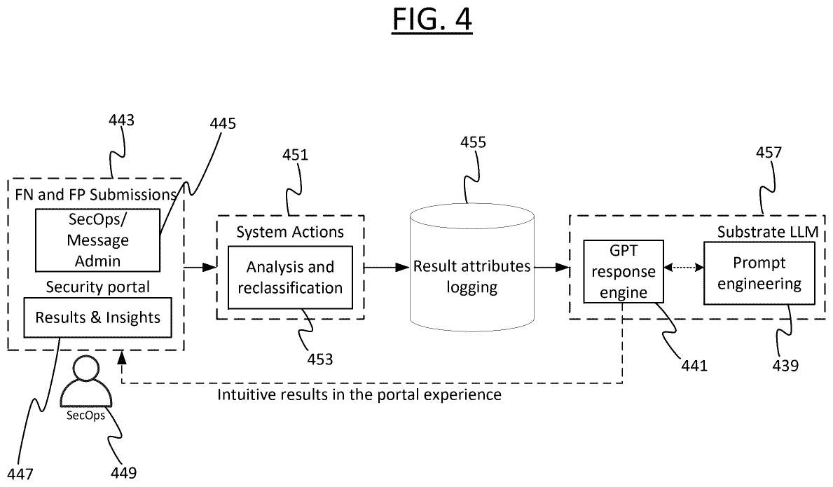

It should be noted that the XAI framework of FIG. 2 can be used for any AI model used for model output 215 (as can the XAI systems used in FIGS. 3 and 4). As such, the XAI framework is model agnostic and can provide an explanation for an output from any AI model.

FIG. 3 shows an example workflow for providing an XAI response. The XAI response may be provided to a user 329. In some examples, the XAI response may be used to perform a physical and/or logical operation. At 323, user 329 may receive a response from an AI model comprising an output prediction or value 327. In some examples, output 327 may be received through a analysis portal used by user 327. Output 327 may be considered to comprise a least one feature. At 325, an explanation request is received for why output 327 was provided by the AI model. For example, the explanation request may be instigated via user input from user 329. This may be performed on demand (when user 327 requests reasoning) or may be performed as a default for some or all users. In some examples, the ability for user 329 to request the reasoning may depend on a user status (for example, if the user 329 is indicated as high priority or as a developer, user 329 can request an explanation for output 327).

At 331, a scenario for which an inquiry is received at 323 is mapped. The scenario may comprise a combination of user 329's request for reasoning and the output 327. The scenario can then be used to retrieve information correlated with the scenario from data store 335. The information retrieved from data store 335 comprises at least one attribute input into the AI model to provide output 327. In some examples, pre-processing can then be performed to extract the most useful data points from data store 335 that can be considered to generate an explanation of output 327. Some data points may be more useful for certain scenarios than others. Less useful attributes may be ignored by excluding low fidelity attributes/features to reduce noise.

The information input into the AI model (note that this information may or may not be pre-processed as described above and note also that this information may be in the form of a feature vector comprising raw data attribute values), information describing the user request scenario and output 327 may then by input into a generative ML model service (in this example, LLM service 337, although it should be noted that in other examples other generative ML models could be used). Using this information, LLM service 337 can engineer a prompt as described above with respect to FIG. 2. Different instruction templates may be used for different scenarios. In some examples, these design instruction templates can be designed using few-shot learning. A prompt template can be used to provide an instruction and context for a prompt, as well as to provide placeholders for raw data attributes from data store 335. The prompt template can be populated with raw data attributes from data store 335 to provide a prompt. According to some examples, the raw data attributes from data store 335 may be stored as a feature vector comprising a value for each of at least one of the raw data attributes.

In the example of FIG. 3, the prompt engineered at 339 can then be input into GPT response engine 341 (it should be noted that in other examples, other generative ML models may be used). GPT response engine 341 may comprise an interpretation LLM (e.g., GPT-4) and an evaluation LLM (e.g., GPT-4) implemented similarly to system 211 of FIG. 2. Using the prompt, the interpretation LLM can develop all required/possible prompt scenarios received at GPT response engine 341. According to some examples, X variations may be generated by the interpretation LLM for each response, where X is a positive integer. The prompt variations may be generated using similar method(s) to the method(s) to generate prompt variations described above with respect to FIG. 2.

The response variations generated by the interpretation LLM of GPT response engine 341 may then be input into the evaluation LLM of GPT response engine 341. The evaluation LLM can evaluate the most appropriate response from the response variation. The evaluation LLM can evaluate the most appropriate response using context information from the prompt engineered at 339. In some examples, the evaluation of the response variations can be performed using external context information that is input separately to explanation request 325 and output 327. In some examples, a combination of external context information and context information from prompt 213 may be used. A priority score may be assigned to each response variation based on relevance to the context of scenario inquiry 323, or on the similarity to other variations generated by the interpretation LLM. A rule-based system may then be used to determine if the response variation with the highest priority score satisfies one or more rules (similar to the rules discussed above with respect to FIG. 2). GPT response engine 341 may iteratively generate responses using the interpretation LLM and evaluate the generated responses using the evaluation LLM until the rules are satisfied. The failure of the response variation to satisfy the rules may be fed back to the interpretation LLM and/or evaluation LLM in order to train the respective LLM in the next iteration. In other examples the LLMs may be varied without feedback. In some examples, the prompt may also be varied in the next iteration. When the rules are satisfied by a response variation, the variation may be provided as an XAI response for output 327 and provided to user 329. The XAI response may be used for at least one of:
providing an explanation to user 329 for why output 327 was provided by the AI model;
identifying a reason for a false positive or a false negative in either the AI model's output 327 or in a method that provides a different result to the AI model;
tuning the AI model;
changing a method that provides a different result to the AI model;
determining to perform an physical and/or logical action based on output 327.

FIG. 4 provides an example workflow for providing an XAI response to a SecOps admin 449 (who may additionally or alternatively be an SOC analyst). Users of a security portal may report false positives and/or false negatives by reporting emails, URLs or files through a “submissions” feature 443. The SecOps admin may request reasoning as for a result 447 output by an AI model. This may be performed on demand (when SecOps admin 447 requests reasoning) or may be performed as a default for some or all users. In some examples, the ability for SecOps admin 449 to request the reasoning may depend on their user status (for example, if the SecOps admin 449 is indicated as high priority or as a developer, SecOps admin 449 can request an explanation for output 447).

At 451, a scenario of a submission for a false negative or false positive explanation received at 443 is mapped. The scenario may comprise a combination of SecOps admin 449's request for reasoning for the generation of the false negative or false positive and the output 447. The scenario can then be used to retrieve information correlated with the scenario from data store 445. The information retrieved from data store 445 comprises at least one attribute input into the AI model to provide output 447. In some examples, pre-processing can then be performed to extract the most useful data points from data store 455 that can be considered to generate an explanation of output 447. For example, at least one of the following attributes and their corresponding values may be extracted: URL; sender; recipient; subject; attachment. Less useful attributes may be ignored by excluding low fidelity attributes/features to reduce noise. For example, HTML tags may be ignored.

The information input into the AI model (note that the information may or may not be pre-processed as described above and note also that this information may be in the form of a feature vector comprising raw data attribute values), information describing the SecOps admin's request scenario and output 447 may then by input into Substrate LLM 457. Using this information, the substrate LLM 457 can engineer a prompt as described above with respect to FIG. 2. Different instruction templates may be used for different scenarios. In some examples, these design instruction templates can be designed using few-shot learning. A prompt template can be used to provide an instruction and context for a prompt, as well as to provide placeholders for raw data attributes from data store 455. The prompt template can be populated with raw data attributes from data store 455 to provide a prompt. According to some examples, the raw data attributes from data store 335 may be stored as a feature vector comprising a value for each of at least one of the raw data attributes.

The prompt engineered at 439 can then be input into GPT response engine 441 (although it should be noted that in other examples, other generative ML models may be used). GPT response engine 441 may comprise an interpretation LLM (e.g., GPT-4) and an evaluation LLM (e.g., GPT-4) similarly to system 211 of FIG. 2. Using the prompt, the interpretation LLM can develop all required/possible prompt scenarios received at GPT response engine. According to some examples, X variations may be generated by the interpretation LLM for each response, where X is a positive integer. The prompt variations may be generated using similar method(s) to the method(s) to generate prompt variations described above with respect to FIG. 2.

The response variations generated by the interpretation LLM of GPT response engine 441 may then by input into the evaluation LLM of GPT response engine 441. The evaluation LLM can evaluate the most appropriate response from the response variation. A priority score may be assigned to each response variation based on relevance to a context of submission 443. A rule-based system may then be used to determine if the response variation with the highest priority score satisfies one or more rules (similar to the rules discussed above with respect to FIG. 2). GPT response engine 441 may iteratively generate responses using the interpretation LLM and evaluate the generated responses using the evaluation LLM until the rules are satisfied. When the rules are satisfied by a response variation, the variation may be provided as an XAI response for output 447 and provided to SecOps admin 449. This can provide a reasoning for the false negative or false positive provided at 447 to SecOps admin 449. This can then be used to tune the AI model to avoid further false negatives or false positives. In other examples, the reasoning could be used to expose a flaw in the SecOps admin 449's reasoning that there is a false positive or false negative. The XAI response may be used for at least one of:
providing an explanation to user 449 for why output 447 was provided by the AI model;
identifying a reason for a false positive or a false negative in either the AI model's output 447 or in a method that provides a different result to the AI model;
tuning the AI model;
changing a method that provides a different result to the AI model;
determining to perform a cybersecurity mitigation action based on output 447;
validating a visual assessment of an image;
instructing performance of an industrial process;
verifying a network configuration;
controlling a vehicle.

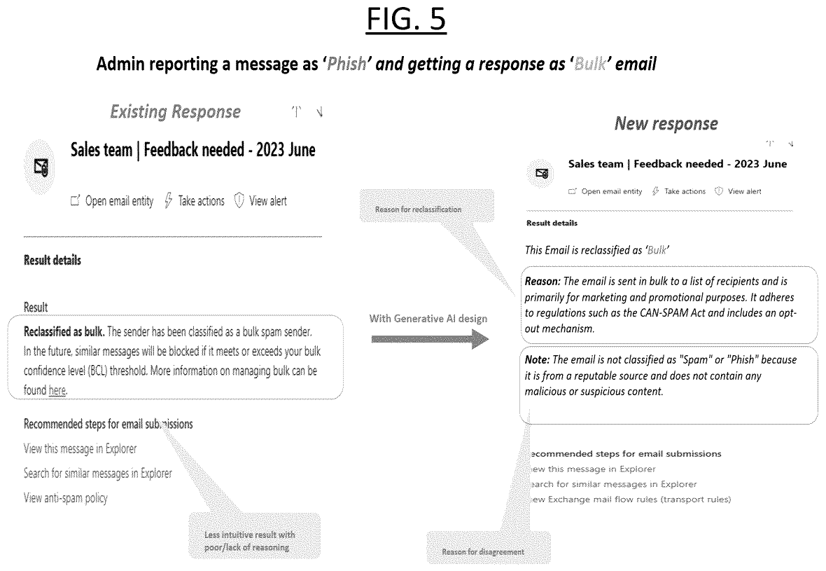

FIG. 5 shown an example of an explanation for an AI model result provided using a non-generative AI approach (such as FIG. 1) on the left and using the generative AI approach described herein (such as in FIG. 2 to 4) on the right. In the example of FIG. 5, a user (an admin in the system) has reported an email as “Phish” to the system. An AI model has reclassified the email as “Bulk”. The user has requested reasoning for the disagreement between their “Phish” finding and the AI model's “Bulk” finding. In the approach taken on the left, a less intuitive result is provided only stating why the email was reclassified as “Bulk” by the AI model. On the right, according to the method described herein, a more intuitive reason for the “Bulk” reclassification is provided by the AI model. Further, a reason for the classification is provided, as the scenario information can be used in the prompt to the GPT response engine to inform the GPT response engine that the user had disagreed with the AI model's classification. In some examples, the scenario information can be used in the prompt to the GPT response engine to inform the GPT response engine specifically that the use had previously classified the email as “Phish”.

A sample prompt template is given in Table 1. The sample prompt comprises context information indicating that a model is used to classify email and that the model is an LightGBM model. The definition of the labels determined by the AI model are also provided. An instruction for an interpretation LLM is also provided. Model features and definitions are also provided, and placeholders for raw data attributes are also provided. An explanation placeholder is also provided.

TABLE 1
A sample prompt template

```
Context: I have an LightGBM model that classifies email into Spam or Not Spam based
on a set of features.
The definitions of the labels are:
- ″ Not Spam″: Not Spam email is communication originating from a reputable sender
domain, addressed to a specific recipient, and containing content that is meaningful,
relevant, and free of phishing or spam.
- ″Spam″: Spam refers to unsolicited or unwanted email. These messages are often sent
in bulk and typically contain advertising or promotional content.
Instruction: GPT-3, please analyze the given email and provide a concise explanation
for why the LightGBM model might have assigned the specific label to it. Consider
the features of the model and their definitions in your analysis.
XGBoost LightGBM Model Features and Definitions:
Subject length: length of the subject
Body length: length of the body
Keywords : contains spam keywords like ‘FREE’, ‘$’, etc.
Auth status: the authentication status of the message
Num urls: number of urls in the email
Num attachments: number of attachments in the email
Sender-recipient relationship:
    - Established
    - Not established
Email / LightGBM features:
Email Details:
Subject length: [SubjectLength]
Body length: [BodyLength]
Keywords : [Keywords]
Auth status: {row.CAUTH]
Num urls: {row.NumUrls]
Num attachments: {row.NumAttachments]
  Sender-recipient relationship: [Relationship]
Body:
[EmailBody]
Assigned Label by LightGBM Model: [Label]
Explanation:
```

Table 2 shows an example response that may be provided by the XAI model described herein.

TABLE 2
A example XAI response

DocuSign lure coming from a suspicious sender domain of “XXX”[.]com.
While clicking on the button in the body, the link is routing to an
entirely different domain.
This email is part of a DocuSign Phish campaign weaponized after delivery
for malicious activity.

Table 3 shows a further example response that may be provided by the XAI model described herein.

TABLE 3
A example XAI response

Email thread looks random with non-related content.
Sender shows as Microsoft but has different domain.
Button link is gibberish domain with recipient email address after
fragment in URL.

Table 4 shows a further example response that may be provided by the XAI model described herein.

TABLE 4
A example XAI response

QR Code Microsoft password expiry Lure.
Sender domain is X LTD but sending “Microsoft” alert. Subject has
recipient domain in text.

The XAI architecture described herein has many practical applications in various fields of technology. In broad terms, the XAI could be used to explain outputs, for example be configured as a declarative network, used for, say, classification or regression tasks (a declarative network, broadly speaking, learns to generate predictions on previously unseen data) or a generative network (which, broadly speaking, can generate new datapoints). Applications of the neural network which can have an explained output include image classification or extracting information from images (e.g. classifying images, image regions, or image pixels; locating objects in images, e.g. by predicting object bounding boxes etc.), text classification, the extraction of structured or semi-structured information from text, audio signal classification (e.g. classifying different parts of an audio signal, e.g. in the context of voice recognition, to separate speech from non-speech, or to convert speech to text), extracting information from sensor signals, e.g. performing measurements using a classification or regression network operating on signals from one or more sensors, for example in a machine control application (e.g. such measurements may be used to measure physical characteristics of or relevant to a machine or system such as a vehicle, robot, manufacturing system, energy production system etc.), or in a medical sensing application such as patient monitoring or diagnostics (e.g. to monitor and classify a patient's vitals). Other applications include generating images (e.g. based on a text or non-text input), text (e.g. translating text from one language to another, or generating a response to a user's text input), audio data (e.g. synthetic speech, music or other sounds) or music (e.g. in digital or symbolic music notation), computer code that may be executed on a processor (e.g. computer code to control or implement a technical process on a computer or machine, e.g. generating code in response to a user's instructions express in natural language, translating or compiling code, such as source code, object code or machine code, from one programming language to another), modeling or simulation of physical, chemical and other technical systems, or discovering new chemical components or new uses thereof (including ‘drug discovery’ applications, to discover new therapeutic compounds or medicines, or new therapeutic uses). Any of the aforementioned applications, among others, may be improved in terms of performance (e.g., accuracy, precision, robustness/reliability) when using the neural network compression method (which, as noted, may be learned and shared across multiple applications/modalities). Further, less memory and/or processing resources are required when performing any of the aforementioned applications by using the neural network compression method. The system also has applications in cybersecurity. For example, a cybersecurity-specific knowledge base may be constructed using the described methods, to support a neural network carrying out a cybersecurity function, such as identifying anomalous or potentially suspicious data points or signals in cybersecurity data (which may, for example, embody cybersecurity telemetry collected using endpoint software and/or network monitoring component(s) etc.), or patterns indicative of potentially suspicious activity or behavior, so that an appropriate reporting, remediation or other cybersecurity action may be taken (e.g. generating an alert, terminating or quarantining an application, service or process, revoking user or application privileges etc.) based on an output of the neural network supported by the knowledge base (e.g. a detection output indicating potentially suspicious activity/behavior that has been detected, or another form of cybersecurity detection outcome). A generative cybersecurity model supported by a knowledge base may, for example, be configured to generate ‘synthetic’ cybersecurity data e.g., for the purpose of training, testing or validating other cybersecurity component(s) and model(s).

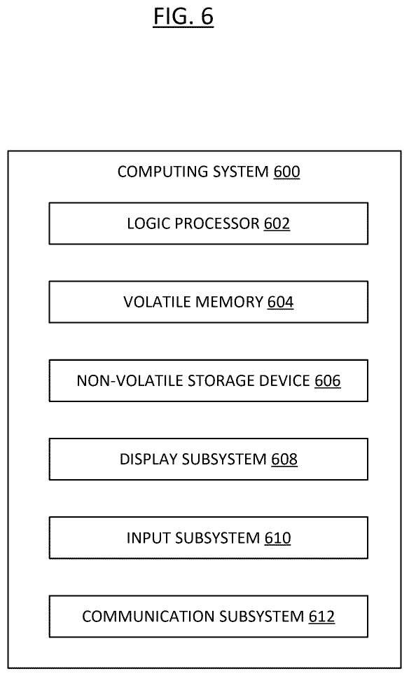

FIG. 6 schematically shows a non-limiting example of a computing system 600, such as a computing device or system of connected computing devices, that can enact one or more of the methods or processes described above. Computing system 600 is shown in simplified form. Computing system 600 includes a logic processor 602, volatile memory 604, and a non-volatile storage device 606. Computing system 600 may optionally include a display subsystem 608, input subsystem 610, communication subsystem 612, and/or other components not shown in FIG. 6. Logic processor 602 comprises one or more physical (hardware) processors configured to carry out processing operations. For example, the logic processor 602 may be configured to execute instructions that are part of one or more applications, programs, routines, libraries, objects, components, data structures, or other logical constructs. The logic processor 602 may include one or more hardware processors configured to execute software instructions based on an instruction set architecture, such as a central processing unit (CPU), graphical processing unit (GPU) or other form of accelerator processor. Additionally or alternatively, the logic processor 602 may include a hardware processor(s)) in the form of a logic circuit or firmware device configured to execute hardware-implemented logic (programmable or non-programmable) or firmware instructions. Processor(s) of the logic processor 602 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor 602 may be virtualized and executed by remotely accessible, networked computing devices configured in a cloud-computing configuration. In such a case, these virtualized aspects are run on different physical logic processors of various different machines. Non-volatile storage device 606 includes one or more physical devices configured to hold instructions executable by the logic processor 602 to implement the methods and processes described herein. When such methods and processes are implemented, the state of non-volatile storage device 606 may be transformed—e.g., to hold different data. Non-volatile storage device 606 may include physical devices that are removable and/or built-in. Non-volatile storage device 606 may include optical memory (e g., CD, DVD, HD-DVD, Blu-Ray Disc, etc.), semiconductor memory (e g., ROM, EPROM, EEPROM, FLASH memory, etc.), and/or magnetic memory (e.g., hard-disk drive), or other mass storage device technology. Non-volatile storage device 606 may include nonvolatile, dynamic, static, read/write, read-only, sequential-access, location-addressable, file-addressable, and/or content-addressable devices. Volatile memory 604 may include one or more physical devices that include random access memory. Volatile memory 604 is typically utilized by logic processor 602 to temporarily store information during processing of software instructions. Aspects of logic processor 602, volatile memory 604, and non-volatile storage device 606 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example. The terms “module,” “program,” and “engine” may be used to describe an aspect of computing system 600 typically implemented in software by a processor to perform a particular function using portions of volatile memory, which function involves transformative processing that specially configures the processor to perform the function. Thus, a module, program, or engine may be instantiated via logic processor 602 executing instructions held by non-volatile storage device 606, using portions of volatile memory 604. Different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc. When included, display subsystem 608 may be used to present a visual representation of data held by non-volatile storage device 606. The visual representation may take the form of a graphical user interface (GUI). As the herein described methods and processes change the data held by the non-volatile storage device, and thus transform the state of the non-volatile storage device, the state of display subsystem 608 may likewise be transformed to visually represent changes in the underlying data. Display subsystem 608 may include one or more display devices utilizing virtually any type of technology. Such display devices may be combined with logic processor 602, volatile memory 604, and/or non-volatile storage device 606 in a shared enclosure, or such display devices may be peripheral display devices. When included, input subsystem 610 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor. When included, communication subsystem 612 may be configured to communicatively couple various computing devices described herein with each other, and with other devices. Communication subsystem 612 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 600 to send and/or receive messages to and/or from other devices via a network such as the internet. The term computer readable media as used herein may include computer storage media. Computer storage media may include volatile and non-volatile, removable and nonremovable media (e.g., volatile memory 604 or non-volatile storage 606) implemented in any method or technology for storage of information, such as computer readable instructions, data structures, or program modules. Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information, and which can be accessed by a computing device (e.g. the computing system 600 or a component device thereof). Computer storage media does not include a carrier wave or other propagated or modulated data signal. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct wired connection, and wireless media such as acoustic, radio frequency (RF), infrared, and other wireless media.

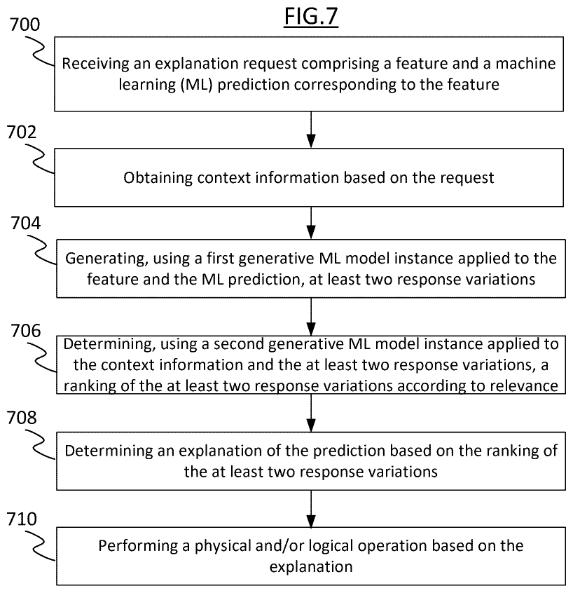

FIG. 7 shows an example method flow XAI. At 700, the method comprises receiving an explanation request comprising a feature and an ML prediction corresponding to the feature.

At 702, the method comprises obtaining context information based on the request. The context information may be received in the request. In some examples the context information may additionally or alternatively comprise information external to the request.

At 704, the method comprises generating, using a first generative ML model instance applied to the feature and the ML prediction, at least two response variation.

At 706, the method comprises determining, using a second generative ML model instance applied to the context information and the at least two response variations, a ranking of the at least two response variations according to relevance.

At 708, the method comprises determining an explanation of the prediction based on the ranking of the at least two response variations.

At 710, the method comprises performing a physical and/or logical operation based on the explanation.

According to an aspect, there is provided a computer-implemented method comprising: receiving an explanation request comprising a feature and a machine learning (ML) prediction corresponding to the feature; obtaining context information based on the request; generating, using a first generative ML model instance applied to the feature and the ML prediction, at least two response variations; determining, using a second generative ML model instance applied to the context information and the at least two response variations, a ranking of the at least two response variations according to relevance; determining an explanation of the prediction based on the ranking of the at least two response variations; and performing a physical and/or logical operation based on the explanation.

According to some examples, the first generative ML model instance comprises a first large language model instance and the second generative ML model instance comprises a second large language model instance.

According to some examples, performing the physical and/or logical operation based on the explanation comprises outputting the explanation.

According to some examples, performing the physical and/or logical operation based on the explanation comprises: modifying based on the explanation of the prediction a parameter of a machine learning model associated with the ML prediction.

According to some examples, performing the physical and/or logical operation based on the explanation comprises: causing a cybersecurity mitigation action to be performed based on the prediction and the explanation of the prediction.

According to some examples, the cybersecurity mitigation action comprises at least one of: isolating a malicious actor from a network; removing or restricting privileges of a malicious actor; generating an alert identifying the malicious actor at a user interface; gathering additional details relating to the malicious actor.

According to some examples, the method comprises: training a cybersecurity detector based on the explanation of the prediction; detecting a malicious actor using the cybersecurity detector; performing the cybersecurity mitigation action to be performed for the detected malicious actor.

According to some examples, the explanation request comprises a second prediction corresponding to the feature and the explanation of the prediction comprises an explanation of a difference between the ML prediction and the second prediction.

According to some examples, determining the explanation of the prediction based on the ranking of the at least two response variations comprises determining whether a highest ranked response variation of the at ranked at least two response variations satisfies at least one rule, wherein the method comprises: determining a highest ranked response variation of the at least two response variations as a candidate explanation of the prediction when the highest ranked response variation satisfies the at least one rule; generating, when the candidate explanation does not satisfy the at least one rule, a further at least two response variations using the first large language model instance applied to the feature and the ML prediction based on the request.

According to some examples, the at least one rule comprises: a relevance threshold to be satisfied by the response to the explanation request; a clarity threshold to be satisfied by the response to the explanation request; a rule describing a tone of the explanation of the prediction; a rule describing adherence to a style guide for the explanation of the prediction.

According to some examples, the at least two response variations comprises: at least three response variations and the ranking the at least two responses is based on the similarity of each of the at least three response variations to the other response variations of the at least three response variations.

According to some examples, the method comprises selecting a prompt template corresponding to the explanation request; wherein generating the at least two response variations comprises: generating the at least two response variations using the prompt template.

According to some examples, the prompt template comprises at least one of: information describing a ML model being used to output the ML prediction; information describing at least one label definition of the ML model; an instruction to provide an explanation for the ML prediction being output from the ML model; an instruction specifying the type of explanation; at least one placeholder for a corresponding value of the feature.

According to an aspect there is provided a computer device comprising: a processing unit; a memory coupled to the processing unit and configured to store executable instructions which, upon execution by the processing unit, are configured to cause the processing unit to: receive an explanation request comprising a feature and a machine learning (ML) prediction corresponding to the feature; obtain context information based on the request; generate, using a first generative ML model instance applied to the feature and the ML prediction, at least two response variations; determine, using a second generative ML model instance applied to the context information and the at least two response variations, a ranking of the at least two response variations according to relevance; determine an explanation of the prediction based on the ranking of the at least two response variations; and perform a physical and/or logical operation based on the explanation.

According to some examples, the first generative ML model instance comprises a first large language model instance and the second generative ML model instance comprises a second large language model instance.

According to some examples, performing the physical and/or logical operation based on the explanation comprises outputting the explanation.

According to some examples, performing the physical and/or logical operation based on the explanation comprises: modify based on the explanation of the prediction a parameter of a machine learning model associated with the ML prediction.

According to some examples, performing the physical and/or logical operation based on the explanation comprises: causing a cybersecurity mitigation action to be performed based on the prediction and the explanation of the prediction.

According to some examples, the cybersecurity mitigation action comprises at least one of: isolating a malicious actor from a network; removing or restricting privileges of a malicious actor; generating an alert identifying the malicious actor at a user interface; gathering additional details relating to the malicious actor.

According to some examples the executable instructions, upon execution by the processing unit, are configured to cause the processing unit to perform: training a cybersecurity detector based on the explanation of the prediction; detecting a malicious actor using the cybersecurity detector; performing the cybersecurity mitigation action to be performed for the detected malicious actor.

According to some examples, the explanation request comprises a second prediction corresponding to the feature and the explanation of the prediction comprises an explanation of a difference between the ML prediction and the second prediction.

According to some examples, determining the explanation of the prediction based on the ranking of the at least two response variations comprises determining whether a highest ranked response variation of the at ranked at least two response variations satisfies at least one rule, wherein the executable instructions, upon execution by the processing unit, are configured to cause the processing unit to perform: determining a highest ranked response variation of the at least two response variations as a candidate explanation of the prediction when the highest ranked response variation satisfies the at least one rule; generating, when the candidate explanation does not satisfy the at least one rule, a further at least two response variations using the first large language model instance applied to the feature and the ML prediction based on the request.

According to some examples, the at least one rule comprises: a relevance threshold to be satisfied by the response to the explanation request; a clarity threshold to be satisfied by the response to the explanation request; a rule describing a tone of the explanation of the prediction; a rule describing adherence to a style guide for the explanation of the prediction.

According to some examples, the at least two response variations comprises at least three response variations and the ranking the at least two responses is based on the similarity of each of the at least three response variations to the other response variations of the at least three response variations.

According to some examples, the executable instructions, upon execution by the processing unit, are configured to cause the processing unit to perform: selecting a prompt template corresponding to the explanation request; wherein generating the at least two response variations comprises generating the at least two response variations using the prompt template.

According to some examples the prompt template comprises at least one of: information describing a ML model being used to output the ML prediction; information describing at least one label definition of the ML model; an instruction to provide an explanation for the ML prediction being output from the ML model; an instruction specifying the type of explanation; at least one placeholder for a corresponding value of the feature.

According to an aspect, there is provided a computer-readable storage device comprising instructions executable by a processor for: receiving an explanation request comprising a feature and a machine learning (ML) prediction corresponding to the feature; obtaining context information based on the request; generating, using a first generative ML model instance applied to the feature and the ML prediction, at least two response variations; determining, using a second generative ML model instance applied to the context information and the at least two response variations, a ranking of the at least two response variations according to relevance; determining an explanation of the prediction based on the ranking of the at least two response variations; and performing a physical and/or logical operation based on the explanation.

The examples described herein are to be understood as illustrative examples of embodiments of the invention. Further embodiments and examples are envisaged. Any feature described in relation to any one example or embodiment may be used alone or in combination with other features. In addition, any feature described in relation to any one example or embodiment may also be used in combination with one or more features of any other of the examples or embodiments, or any combination of any other of the examples or embodiments. Furthermore, equivalents and modifications not described herein may also be employed within the scope of the invention, which is defined in the claims.

What is claimed is:

1. A computer-implemented method comprising:
receiving an explanation request comprising a feature and a machine learning (ML) prediction corresponding to the feature;
obtaining context information based on the request;
generating, using a first generative ML model instance applied to the feature and the ML prediction, at least two response variations;
determining, using a second generative ML model instance applied to the context information and the at least two response variations, a ranking of the at least two response variations according to relevance;
determining an explanation of the prediction based on the ranking of the at least two response variations; and
performing a physical and/or logical operation based on the explanation.

2. The computer-implemented method according to claim 1, wherein the first generative ML model instance comprises a first large language model instance and the second generative ML model instance comprises a second large language model instance.

3. The computer-implemented method according to claim 1, wherein performing the physical and/or logical operation based on the explanation comprises outputting the explanation.

4. The computer-implemented method according to claim 1, wherein performing the physical and/or logical operation based on the explanation comprises:
modifying based on the explanation of the prediction a parameter of a machine learning model associated with the ML prediction.

5. The computer-implemented method according to claim 1, wherein performing the physical and/or logical operation based on the explanation comprises:
causing a cybersecurity mitigation action to be performed based on the prediction and the explanation of the prediction.

6. The computer-implemented method according to claim 5, wherein the cybersecurity mitigation action comprises at least one of:
isolating a malicious actor from a network;
removing or restricting privileges of a malicious actor;
generating an alert identifying the malicious actor at a user interface;
gathering additional details relating to the malicious actor.

7. The computer-implemented method according to claim 5, the method comprising:
training a cybersecurity detector based on the explanation of the prediction;
detecting a malicious actor using the cybersecurity detector;
performing the cybersecurity mitigation action to be performed for the detected malicious actor.

8. The computer-implemented method according to claim 1, wherein the explanation request comprises a second prediction corresponding to the feature and the explanation of the prediction comprises an explanation of a difference between the ML prediction and the second prediction.

9. The computer-implemented method according to claim 1, wherein determining the explanation of the prediction based on the ranking of the at least two response variations comprises determining whether a highest ranked response variation of the at ranked at least two response variations satisfies at least one rule, wherein the method comprises:
determining a highest ranked response variation of the at least two response variations as a candidate explanation of the prediction when the highest ranked response variation satisfies the at least one rule;
generating, when the candidate explanation does not satisfy the at least one rule, a further at least two response variations using the first large language model instance applied to the feature and the ML prediction based on the request.

10. The computer-implemented method according to claim 9, wherein the at least one rule comprises:
a relevance threshold to be satisfied by the response to the explanation request;
a clarity threshold to be satisfied by the response to the explanation request;
a rule describing a tone of the explanation of the prediction;
a rule describing adherence to a style guide for the explanation of the prediction.

11. The computer-implemented method according to claim 1, wherein the at least two response variations comprises at least three response variations and the ranking the at least two responses is based on the similarity of each of the at least three response variations to the other response variations of the at least three response variations.

12. The computer-implemented method according to claim 1, the method comprising:
selecting a prompt template corresponding to the explanation request;
wherein generating the at least two response variations comprises generating the at least two response variations using the prompt template.

13. The computer-implemented method according to claim 12, wherein the prompt template comprises at least one of:
information describing a ML model being used to output the ML prediction;
information describing at least one label definition of the ML model;
an instruction to provide an explanation for the ML prediction being output from the ML model;
an instruction specifying the type of explanation;
at least one placeholder for a corresponding value of the feature.

14. A computer device comprising:
a processing unit;
a memory coupled to the processing unit and configured to store executable instructions which, upon execution by the processing unit, are configured to cause the processing unit to:
receive an explanation request comprising a feature and a machine learning (ML) prediction corresponding to the feature;
obtain context information based on the request;
generate, using a first generative ML model instance applied to the feature and the ML prediction, at least two response variations;
determine, using a second generative ML model instance applied to the context information and the at least two response variations, a ranking of the at least two response variations according to relevance;
determine an explanation of the prediction based on the ranking of the at least two response variations; and
perform a physical and/or logical operation based on the explanation.

15. The computer device according to claim 14, wherein the first generative ML model instance comprises a first large language model instance and the second generative ML model instance comprises a second large language model instance.

16. The computer device according to claim 14, wherein performing the physical and/or logical operation based on the explanation comprises outputting the explanation.

17. The computer device according to claim 14, wherein performing the physical and/or logical operation based on the explanation comprises:
modify based on the explanation of the prediction a parameter of a machine learning model associated with the ML prediction.

18. The computer device according to claim 14, wherein performing the physical and/or logical operation based on the explanation comprises:
causing a cybersecurity mitigation action to be performed based on the prediction and the explanation of the prediction.

19. The computer device according to claim 18, wherein the cybersecurity mitigation action comprises at least one of:
isolating a malicious actor from a network;
removing or restricting privileges of a malicious actor;
generating an alert identifying the malicious actor at a user interface;
gathering additional details relating to the malicious actor.

20. A computer-readable storage device comprising instructions executable by a processor for:
receiving an explanation request comprising a feature and a machine learning (ML) prediction corresponding to the feature;
obtaining context information based on the request;
generating, using a first generative ML model instance applied to the feature and the ML prediction, at least two response variations;
determining, using a second generative ML model instance applied to the context information and the at least two response variations, a ranking of the at least two response variations according to relevance;
determining an explanation of the prediction based on the ranking of the at least two response variations; and
performing a physical and/or logical operation based on the explanation.
